(19) United States
(12) Patent Application Publication
(10) Pub. No.: US 2016/0283924 A1
(43) Pub. Date: Sep. 29, 2016

(54) SYSTEM WITH AN INTERACTIVE WEBSITE APPLICATION FOR PROCESSING A TRANSACTION

(71) Applicant: Mina Rizk, Lexington, KY (US)

(72) Inventor: Mina Rizk, Lexington, KY (US)

(21) Appl. No.: 14/672,187

(22) Filed: Mar. 29, 2015

(51) Int. Cl. G06Q 20/12; G06Q 20/20; G06F 17/30

(52) U.S. Cl. CPC G06Q 20/12; G06F 17/30528; G06F 17/30368; G06Q 20/202

(57) ABSTRACT

The present invention relates to implementing a system for enhancing an online purchasing transaction by allowing a client to provide transaction details through an activated website application. The website application provides a user interface for the client to enter the purchasing details without a need for a clerk to enter the details. The purchasing details entered by the client can be edited or modified by the clerk online within the dealer network. Further, the website application assists the client in performing functionalities such as searching, submitting, and/or verifying the client purchased details. Further, a plurality of servers is used for processing the transaction associated with the client, and the updated or the edited details of the client are stored in the customer account.

### FIELD OF THE INVENTION

The present invention generally relates to enhancing an online purchasing transaction process for a client and more particularly relates to implementing a system with an interactive website application for enhancing the online purchasing transaction initiated by a client at a dealer location using dealer's device within a dealer network.

### BACKGROUND OF THE INVENTION

Currently, most of the dealers are interested in selling goods or products or services to a client online by using various website services available in the market. In the existing website services, the dealer's signup with one of the websites and the client goes to the dealer location for taking help from the clerk to purchase one or more products or services and provides all the necessary information to the clerk. Further, the clerk chooses the product or services the client is interested in purchasing and updates the information into the website to process the transaction, and the client gets a receipt or a text message with confirmation of the transaction. In a Kiosk type of purchasing service, clients are allowed to choose the product and enter the necessary data for purchasing products or services. Further, the client is allowed to make payment using credit cards.

The existing point of sale (POS) system requires the help of a clerk to enter the customer information, as the customer purchases products and services and has initiated a purchasing transaction. The data entered by the clerk may not be completely devoid of human errors encountered while entering the customer data, mistakes occurring due to language barrier, typographical mistakes occurring while entering customer data, or the like. Further, the data to be entered by the clerk for processing the transaction requires a separate dedicated phone line or data connection line for accepting the transaction inputs from the clerk. This imposes an overhead in terms of providing connectivity for completing the purchasing transaction within the network. Further, the existing online purchasing systems do not provide various modes of payment facility to the customers including cash only option.

Accordingly, there exists a need to implement a website application and/or a comprehensive system that can accept the customer input directly, without a need for a clerk to enter the customer details and an additional connectivity required for processing a purchasing transaction within the network. Further, the website application must support various modes of payment for completing the online purchasing transaction.

### SUMMARY OF THE INVENTION

The present invention relates to a system for enhancing the dealer and client experience for one or more dealers, by allowing a client to provide the transaction details through an electronic device within a dealer's network over wireless fidelity (wifi) network, wherein the system comprises of a website application configured to run on a plurality of servers for storing and processing the initiated online purchasing transaction for one or more clients. Further, the website application is automatically activated when the online transaction is initiated for one or more clients. Furthermore, the website application saves and processes the transaction details in one of the plurality of servers by allowing a clerk to verify, edit, or modify the transaction details and submit the transaction. Additionally, the website application is configured to allow communication between an SMS gateway and the plurality of servers for handling messages with one or more clients within the dealer's network. Further, the website application is configured to allow communication between a merchant gateway and the plurality of servers for handling the online purchasing transaction that is initiated between one or more clients and one or more merchants within the dealer's network.

### BRIEF DESCRIPTION OF DRAWINGS

FIG. 1 illustrates an overview of the system implemented for enhancing the client experience involved in an online purchasing activity.

FIGS. 2a and 2b illustrate a flow-chart that explains the process of enhancing the client experience by activating an interactive website application.

FIG. 3 illustrates a block-diagram with various components used in implementing the interactive website application.

### FIGURE DESCRIPTION

100—An overview of the system implemented for enhancing the client experience

101—A dealer's network in which the system is implemented

102—A tablet or a smart device assigned to a dealer account

103—A computer or a Point of Sale (POS) system assigned to a dealer account

104—Server A on which the storage and online purchasing transaction happens

105—Server B on which the storage and online purchasing transaction happens

106a, 106b, and 106c—Vendor servers

107—A Short Message Service (SMS) gateway

108—A merchant gateway

109—A cell phone device of a client that receives an SMS transaction confirmation text

200—A flow-chart that explains the process of activating an interactive website application, which is connected through a connector A.

300—A system overview depicted with a block-diagram

301—An application interface module

302—A transaction processing module

303—An SMS gateway module

304—A merchant gateway module

305—A controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, a client is an individual person who is interested in purchasing one or more products or services and intends to use the services supported by the website application for completing the online purchasing transaction.

In an embodiment, a dealer is an agent who has configured the website application on his/her system and signs up with the website application services for processing the transaction.

In an embodiment, a clerk is a person working at the dealer's location for reviewing, verifying, processing, and handling transactions.

In an embodiment, a portal is a website application that runs on an electronic device such as a tablet, personal computer (PC), or a Point of Sale (POS) system, which is assigned to a dealer account, and the portal processed transaction is associated with the dealer's account. Hence, the terms portal and/or website application refers to the application that is used to process the transaction associated with the dealer's account.

In an embodiment, a Back of the House System (BOHS) is a dealer's Point of Sale (POS) or a website browser that accesses the dealer's account to process the transaction. Further, the BOHS can be a Personal Computer (PC) where the client transactions can be edited or submitted and the vendor details can be verified before getting the Short Message Service (SMS) message with a confirmation number or product information.

In an embodiment, a server is a place where all the transactions, vendor list, SMS gateway information is stored and processed.

In an embodiment, the term electronic device or a dealer device refers to a device on which a website application can be activated for accepting the client details while involved in an online purchasing activity within a dealer network. The terms electronic device or the dealer device can refer to a mobile phone, a laptop, an ipad, a tablet, a computer, a Point of Sale (POS) system or the like.

In an embodiment, the website application provides a user interface for the client to enter the details on the dealer's system. Further, the website application assists the client in performing search, lookup, choose, submit and verify functionalities based on the client details that is saved and processed in the server.

In an embodiment, a plurality of servers is used for storing the client's information along with a purchases history in the server database. Further, the plurality of servers is used for processing the online purchasing transaction associated with a dealer account.

In an embodiment, the client information and the transaction details entered by the client during an online purchasing activity includes but not limited to a client name, address, phone number, list of items or services purchased by the client, list of vendors selected by the client, payment details associated with a purchasing activity, mode of payment opted by the client.

In an embodiment, the website application allows the client to make payment for an online purchasing activity through various means such as a credit card, a debit card, cash and so on.

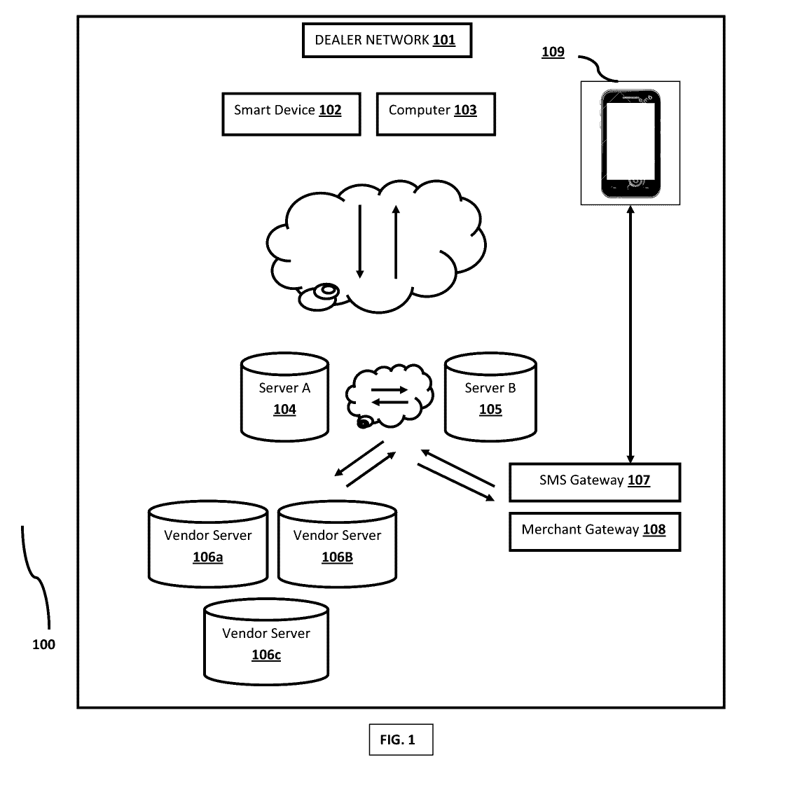

Referring to FIG. 1 illustrates an overview of the system 100 implemented for enhancing the client and dealer experience involved in an online purchasing activity. In an embodiment, when a client is involved in an online purchasing activity, the website application is activated on the electronic device. The website application accepts the client details related to the purchasing activity through a website application interface that is activated on a smart phone 102, a tablet 102, a Point of Sale (POS) system 103, a computer 103, or a cell phone device 109. In an embodiment, the client details entered through the website application interface is stored and processed on a plurality of servers 104, 105 connected to the dealer's electronic device within the dealer's network 101. In an embodiment, the website application is configured to verify the client details on the plurality of servers 104, 105 and save the client details or the transaction details in a queue that is assigned with a unique number. Further, the website application is configured to allow the clerk to extract from the queue the client details or the transaction details that is saved in the queue (based on the unique number associated with the details) to verify and submit the details for further processing. In an embodiment, the activated website application is configured to allow the clerk to edit or modify the customer details or the transaction details before submitting, wherein the client details or the transaction details entered by the client is assigned with a unique number.

In an embodiment, the system 100 is configured to interact with various vendor servers 106a, 106b, and 106c through the servers 104, 105 and based on the client or transaction details entered by the client.

In an embodiment, a Short Message Service (SMS) gateway 107 is configured to send a short message text to the client regarding a transaction that was processed at a dealer location through the website application after it has been processed by the server 104, 105. Further, the server 104, 105 receives a confirmation from the vendor's server 106a, 106b, and 106c through the SMS gateway 107 and the client receives the transactions details along with the confirmation message to initiate a short text on the client devices 102, 103, 109.

In an embodiment, a merchant gateway 108 is configured to receive the customer details from the dealer devices 102, 103, 109 for the merchants involved in an online purchasing activity with one or more clients after the website application is activated on the dealer devices 102, 103, 109 and through the plurality of servers 104, 105. Additionally, the merchant gateway 108 is configured to exchange the payment related details, associated with an online purchasing activity, with one or more dealer devices 102, 103, 109 within the dealer network 101.

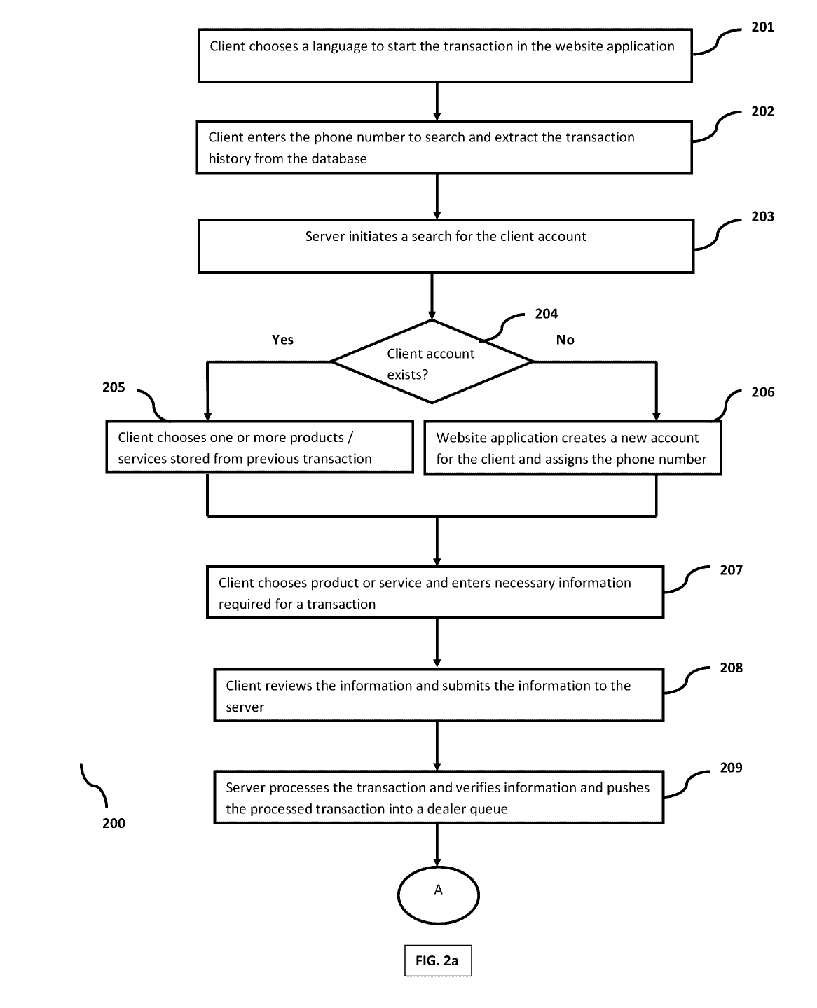

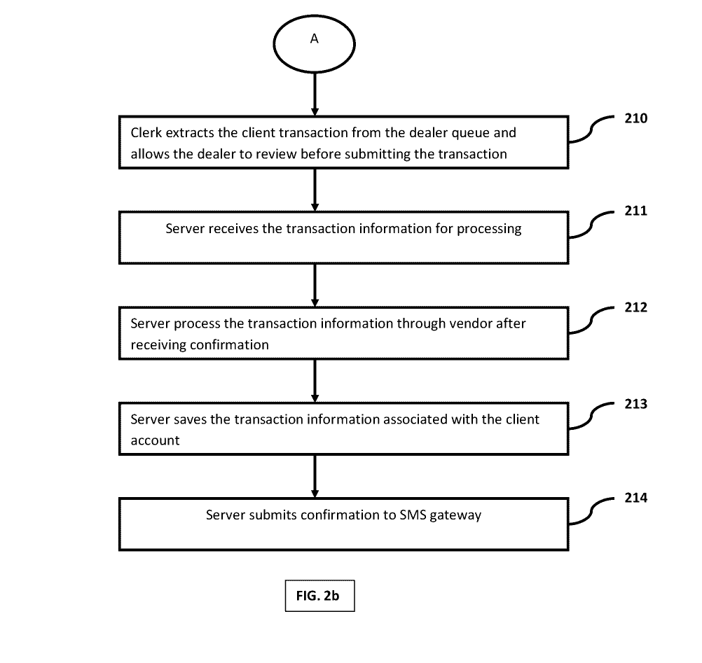

Referring to FIGS. 2a and 2b illustrate a flow-chart 200 that explains the process of enhancing the customer experience by activating an interactive website application while involved in an online purchasing activity. Initially, at step 201, the website application allows the client to choose the desired language to initiate a transaction. At step 202, the website application allows the client to enter his/her account number (for example: a cell phone number). At step 203, the server initiates a search to identify if the account number has already been registered or if a new account has to be created for the client. At step 204, the server determines the availability of the client account in the database. If the client account does not exist in the server, at step 206, the website application creates and saves the client information in the database. If the account already exists or the client is registered before the server, at step 205, the website application will pull up previous transaction for the client to choose from or give the option for the client to purchase a new product or service. At step 207, the client chooses the desired product or service and provides the necessary information required by such product or service. At step 208, the website application allows the client to review the entered information and submit the information to the server 104, 105. At step 209, the server 104, 105 processes the transaction by verifying the submitted information and further pushes the processed transaction in to a dealer's queue. At step 210, the website application allows the clerk or the dealer to pull the transaction from the dealer's queue and verify the transaction or client information and submit the verified transaction or client information to the server 104, 105 for processing. At step 211, the server 104, 105 is initiated to process the verified transaction or the client information. At step 212, the server 104, 105 is configured to process the transaction through the vendor servers 106a, 106b, 106c after receiving confirmation from the vendors. At step 213, the processed transaction is saved in the server 104, 105 associated with the client account. After completing the initiated transaction process, at step 214, the server 104, 105 sends the client transaction detail along with the client phone number to the SMS gateway server 107, which further initiates a short text to be sent to the dealer devices 102, 103, 109 for confirmation of the transaction completion.

The flow-chart depicted by FIG. 2a and FIG. 2b are connected by a connector labeled with a letter A.

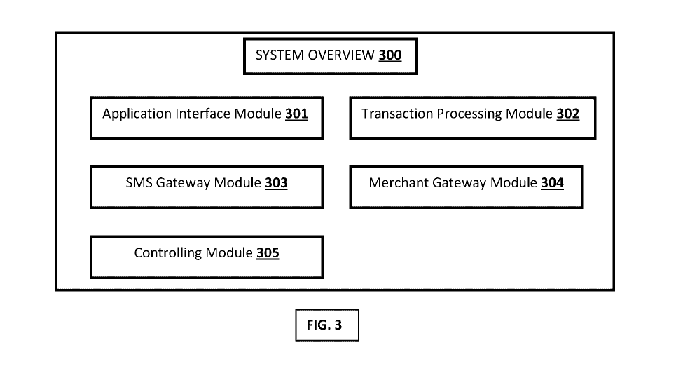

Referring to FIG. 3 illustrates a block-diagram 300 with various components used in implementing the system 100. In an embodiment, the system 100 comprises of the following components: an Application Interface module 301, a Transaction Processing module 302, an SMS gateway module 303, a Merchant gateway module 304, and a Controlling module 305. In an embodiment, the Application interface module 301 is configured to support and activate the website application on the dealer's device 102, 103. In an embodiment, the Transaction processing module 302 is configured to process the online purchasing transaction initiated for a client. The Transaction processing module 302 processes the online purchasing transaction by using a plurality of servers 104, 105 identified within the dealer's network 101. In an embodiment, the SMS gateway module 303 is configured to support message exchange between the system 100 and the dealer devices 102, 102, 109 while an online purchasing activity is initiated within the dealer's network 101 and the website application is activated for the online purchasing activity. In an embodiment, the Merchant gateway module 304 is configured to receive the client details by one or more merchants that are determined for performing an online purchasing transaction. In an embodiment, the Controlling module 305 is configured to transfer data across various modules supported for implementing the system 100 and also to perform additional transaction and/or process related activities.

1. A system implemented to enhance the dealer and client experience for at least one client, while an online purchasing transaction is initiated through an electronic device within a dealer network, wherein the system comprises of:
a means to activate a website application on said electronic device when said online transaction is initiated for said at least one client;
said website application configured to run on said electronic device that accepts said online purchasing transaction related details from said at least one client;
said website application configured to store and process the initiated online purchasing transaction on a plurality of servers for said at least one client;
a Short Message Service (SMS) gateway for handling messages exchanged by said system with said at least one client within said dealer network; and
a merchant gateway for handling said online purchasing transaction that is initiated between said at least one client and at least one merchant within said dealer network.
a method to enhance the customer experience for said at least one client, while an online purchasing transaction is initiated through an electronic device

2. The system as claimed in claim 1, wherein said electronic device can be one of a mobile device, a laptop, a tablet, an ipad or any other device that is connected within a dealer network and is capable of accepting said at least one client input data.

3. The system as claimed in claim 1, wherein said system is configured to enhance the customer experience by performing at least one of following functionalities:
allowing said at least one client to provide the client details online through said web application user interface while an online purchasing transaction is initiated for said at least one client;
enabling a quick and efficient search of a client database to access said at least one client detail; and
allowing a clerk to verify, submit, and/or modify said at least one client detail that is stored in said plurality of servers.

4. The system as claimed in claim 1, wherein said method implemented to enhance said online purchasing transaction for said at least one client comprises of:
accepting said at least one client input through a website application;
determining if a client account exists for said at least one client based on said at least one client input received through said website application;
storing said at least one client input in the form of a client record in said client account that is created for said at least one client;
extracting the most recent online purchasing transaction that is completed for said at least one client, wherein the most recent online purchasing transaction is determined based on said client record that is accessed;
updating or editing said client record that is extracted with said online purchasing transaction details; and
processing said client record for completing said online purchasing transaction that is initiated.

5. The system as claimed in claim 1, wherein said SMS gateway is configured to handle message exchange for said at least one client after said website application is initiated for said online purchasing transaction.

6. The system as claimed in claim 1, wherein said merchant gateway is configured to receive merchant requests from Point-Of-Sale (POS) endpoints of a merchant after said website application is initiated for said online purchasing transaction.

7. The system as claimed in claim 6, wherein said merchant gateway configured to receive the merchant requests that include at least one of client input data which uniquely identifies said at least one client along with said online purchasing transaction details, which is provided to a merchant.
